(19) United States
(12) Patent Application Publication
(10) Pub. No.: US 2003/0131519 A1
(43) Pub. Date: Jul. 17, 2003

(54) Casting net method and apparatus

(76) Inventor: Allison H. Fickling JR., Ridgeland, SC (US)

Correspondence Address: JOSEPH F. PETERS, JR., 40 PLANTATION DRIVE, MANNING, SC, 29102-9040, US

(21) Appl. No.: 10/307,801

(22) Filed: Dec. 2, 2002

Related U.S. Application Data
(60) Provisional application No. 60/338,850, filed on Nov. 30, 2001.

(51) Int. Cl. A01K 73/12

(52) U.S. Cl. 43/14

(57) ABSTRACT

A cast net for trapping fish and other marine life which is modified by the addition of planar element(s) attached to the open peripheral end of a weighted cast net. The added planar elements assist in the planar spread of the cast net when it is thrown in the air. The planar elements also assist in the delayed submergence of the net in the water into which it is cast. In this manner, more marine life is allowed to be entrapped by the net.

This application claims the benefit under 35 U.S.C 119(e) of U.S. Provisional Application No. 60/338,850, filed Nov. 30, 2001.

### FIELD OF THE INVENTION

The invention is directed to an improved apparatus for cast nets used for fishing, shrimping, etc., in particular, to an improved cast net of either the conical or planar type.

### BACKGROUND OF THE INVENTION

The invention is of a particular type of cast net which is used to trap fish, shrimp, or similar water life in a traditional manner, but with an improved feature which allows the cast net to remain open for a longer period of time, thereby trapping more sea life therein. Typically, a cast net is thrown in a manner which forces the associated net into a circular pattern over an area of the water surface. The cast net is then submerged by means of a series of weights attached to the circumference of the net. As the net submerges the weights have a tendency to sink more rapidly than the net between its center and its periphery. Once the net is sufficiently submerged and the circumferential weights converge to close the net, the user then begins the retrieval process, automatically entrapping any sea life trapped in the net. The prior art is exemplified by U.S. Pat. No. 4,790,098 to Pang C. Lu. The Lu patent is directed to an improvement in the typical and well-known cast net used for centuries by Native Americans as well as Third World countries. The device disclosed by Lu is a planar type cast net. In the instant invention, which is equally applicable to either conical or planar cast nets, means are provided on the periphery of the net, in addition to the standard weights, to cause a delayed convergence of the periphery of the net during the submergence thereof and to help force the net into an open position. This allows more sea life to be entrapped within the confines of the cast net as it submerges and the peripheral weights converge. In this manner, more sea life is able to be trapped within the cast net. In addition, the instant invention improves the user's ability to successfully cast the net to ensure proper coverage of the water surface upon which the net is cast.

### SUMMARY OF THE INVENTION

The prime objective of the invention is to improve the efficiency of a cast net of either the conical or planar style. A secondary objective is to improve or simplify the skill required in successfully throwing a cast net.

### BRIEF DESCRIPTION OF THE DRAWINGS

FIG. 1 illustrates a typical prior art device being held by a user immediately prior to casting of the net.

FIG. 2 illustrates the prior art device in the cast position of the net on the surface of the water, immediately prior to the submersion process.

FIG. 3 illustrates the present invention being held by the user immediately prior to casting of the net.

FIG. 4 illustrates the present invention in the cast position of the net on the surface of the water, immediately prior to the submersion process.

### DETAILED DESCRIPTION OF THE INVENTION

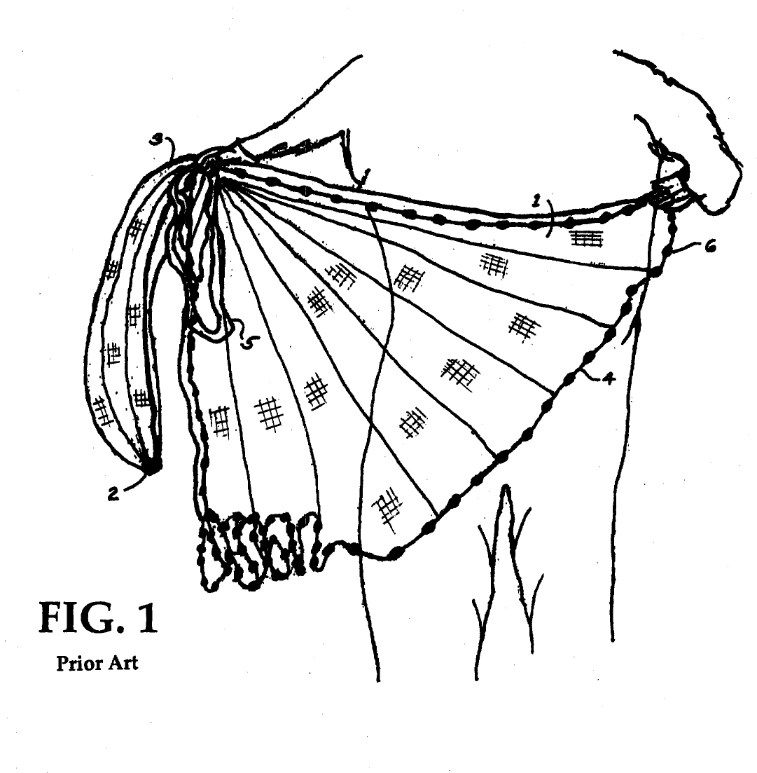

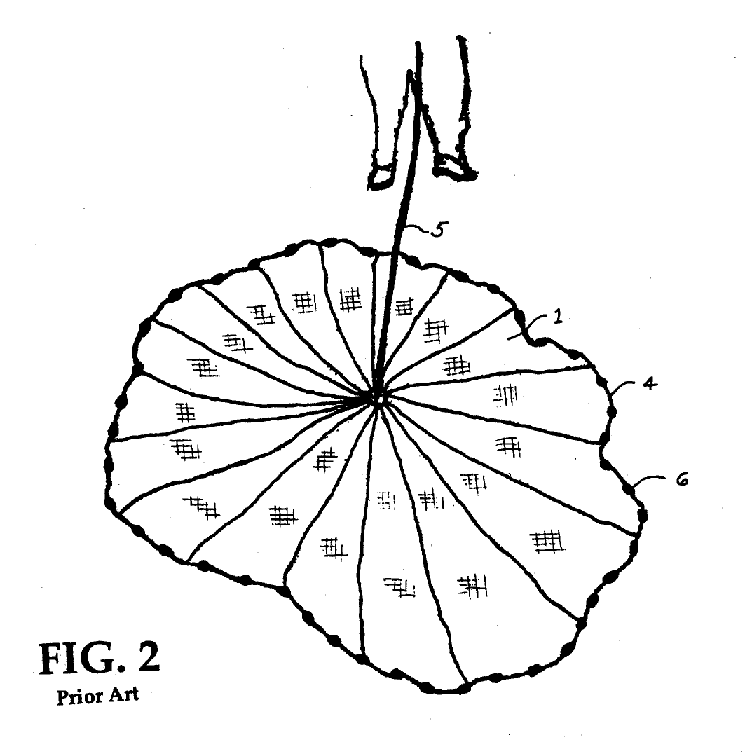

As depicted in FIG. 1, the prior art device comprises a net 1 having a center 2 and a periphery 4. The periphery of the net has a series of weights 6 attached thereto which cause the periphery of the net to sink more rapidly than the remainder of the net. In preparation of casting the net, the user grasps a section 3 of the net somewhat below the center 2 thereof, thereby gathering a top section of the net in one hand of the user. The user grasps a portion of the periphery 4 of the net 1 in the other hand in order to cast the net and cause the peripheral weights to spread the net into an approximately planar configuration upon the surface of the water. The net 1 may be retrieved by means of the attached line 5 which is grasped and retained by the user when casting the net. FIG. 2 depicts the prior art device in the cast position with the periphery 4 of the net being at a maximum distance from the center 2. The peripheral weights 6 are likewise at a maximum distance from the center 2 of the cast net 1.

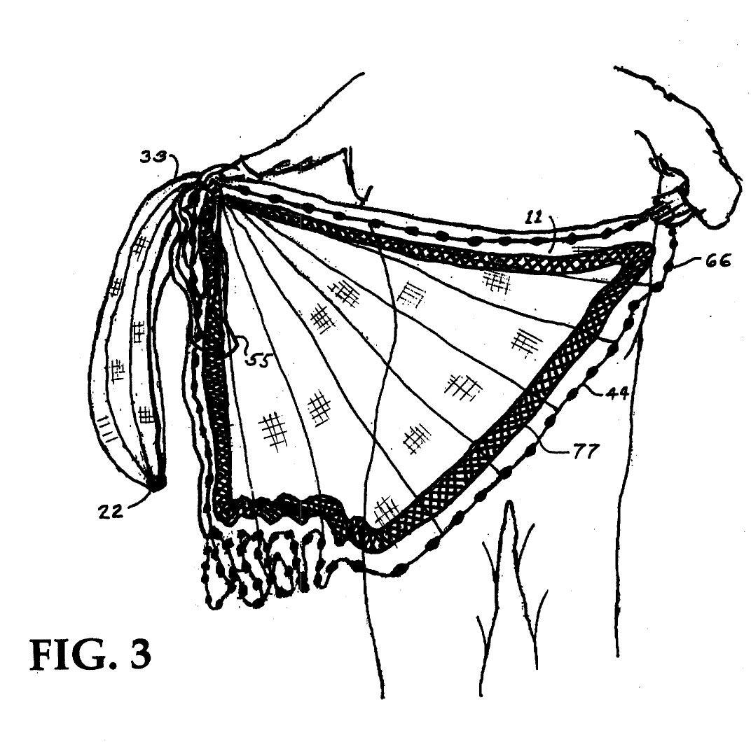

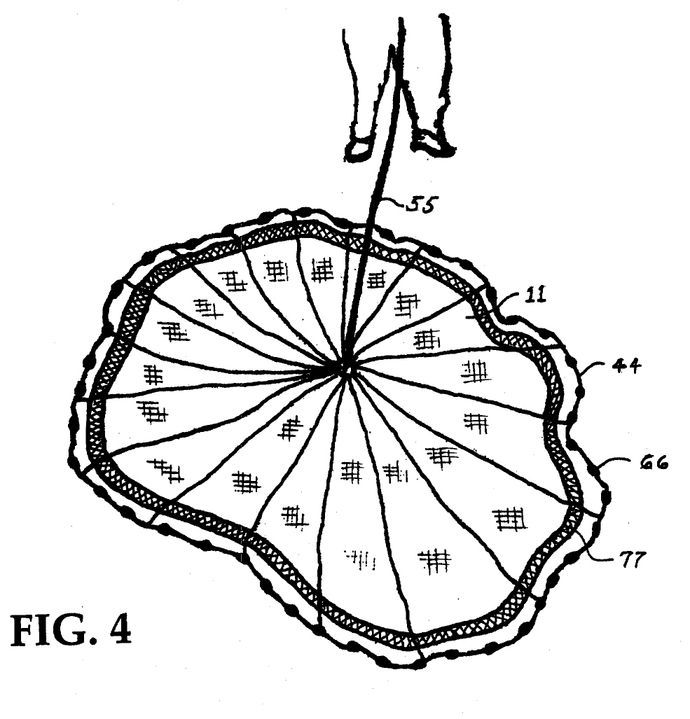

FIG. 3 depicts the instant invention in the same manner as the prior art device of FIG. 1. The net 11 has a center 22, a periphery 44, weights 66 and a retrieval line 55. The user grasps the line 55 and a section 33 of the net 11 in order to cast the net. In the instant invention, means 77 are provided near the periphery of the net to cause the net to delay the submergence thereof. Means 77 may be in the preferred form of duct tape, or any standard form of tape such as cloth, masking, metal, plastic, vinyl, duct or surgical tape. The tape is simply attached to the net as shown in FIG. 3. When the net is cast, as shown in FIG. 4, the tape 77 causes the net to sink at its periphery at a much slower rate than the prior art devices. This allows more time for the periphery of the net to converge and close the net. As a result, more sea life is trapped by the net due to the delayed sinking of the periphery of the net. The means 77 may be in the form of spaced members which have a planar configuration in order to cause the periphery of the net to sink at a slower rate than heretofore possible with the prior art devices. The means 77 acts simply as a planing device with a planar surface to cause the periphery of the net to spread out more effectively and to sink more slowly than with standard weights attached to a cast net. The means 77 may be attached by means of an adhesive, by threading the planing member(s) into the strands of the net or by sewing the planar member(s) near the outer circumference of the casting net. Moreover, the rate of decent and the degree of planing of the net may be changed by merely altering the width of the planing member(s) or by increasing or decreasing the number of planing members attached to the periphery of the net.

This application is intended to cover any means attached to the periphery of a cast net to cause both better spread of the net during casting and delayed sinking of the periphery of the net into the water upon which it is cast.

I claim:

1. A cast net comprising:
a net having conventional weighting means about the peripheral open end thereof and additional means on said peripheral open end thereof to aid in the planar spread of said open end when said net is cast, said additional means also delaying the decent of the periphery of the net during submergence of the net into the water over which it is cast.

2. The cast net of claim 1 wherein said additional means on a periphery of an open end of said net comprises a circumferentially arranged band of material adjacent said periphery of said net.

3. The device of claim 2 wherein said material is selected from the group consisting of cloth, duct, vinyl, masking, metal, plastic and surgical tape.

4. The device of claim 2 wherein said band of material comprises a plurality of spaced apart elements forming a continuous line about the periphery of the open end of said net.

5. The device of claim 1 wherein the net is of a planar configuration.

6. The device of claim 1 wherein the net if of a conical configuration.

7. The method of making a cast net comprising the steps of assembling a conventional cast net having a weighted periphery and applying means on the outer periphery thereof to aid in the planar spread of the net when cast in the air and also delaying the submergence of the periphery of said net into water over which it is cast.

8. The method of claim 7 wherein the means on the outer periphery of the net are applied in a continuous band adjacent the periphery of the net.

9. The method of claim 7 wherein the means on the outer periphery of the net are applied in a discontinuous band adjacent the periphery of the net.

10. The method of claim 7 wherein the means on the outer periphery of said net is a material selected from the group consisting of cloth, duct, vinyl, masking, plastic, metal and surgical tape.
